(19) United States
(12) Patent Application Publication
(10) Pub. No.: US 2025/0370697 A1
(43) Pub. Date: Dec. 4, 2025

(54) DISPLAY METHOD AND DISPLAY SYSTEM

(71) Applicant: SEIKO EPSON CORPORATION, Tokyo (JP)

(72) Inventor: Yusei MOTEGI, SAPPORO-SHI (JP)

(21) Appl. No.: 19/220,252

(22) Filed: May 28, 2025

(30) Foreign Application Priority Data
May 29, 2024 (JP) 2024-087233

(51) Int. Cl. G06F 3/14; H04N 21/4402

(52) U.S. Cl. CPC G06F 3/1462; H04N 21/440245

(57) ABSTRACT

A display method includes: acquiring a master image; acquiring a first aspect ratio of a first display screen of a first display device; setting a first region in a master region of the master image based on the first aspect ratio; displaying, on the first display screen, a first image obtained by trimming an image portion inside the first region in the master image; acquiring a second aspect ratio of a second display screen of a second display device different from the first display device; setting, in the master region, a second region having an overlapping region that overlaps the first region and a non-overlapping region that does not overlap the first region in at least one of a first direction and a second direction that are orthogonal to each other in the master region, based on the second aspect ratio; and displaying, on the second display screen, a second image obtained by trimming an image portion inside the second region in the master image.

The present application is based on, and claims priority from JP Application Serial Number 2024-087233, filed May 29, 2024, the disclosure of which is hereby incorporated by reference herein in its entirety.

### BACKGROUND

### 1. Technical Field

The present disclosure relates to a display method and a display system.

### 2. Related Art

A system is known in which an image is supplied from a smartphone to a projector, and the projector projects the image (see, for example, JP-A-2017-97107).

JP-A-2017-97107 discloses that a smartphone and a projector are coupled to each other and, for example, Miracast (registered trademark) is coupled to a wireless communication interface.

JP-A-2017-97107 discloses that, in the projector, when the smartphone coupled to the projector is used in a so-called vertical direction and a digital micro-mirror device (DMD) is used in a normal use state, projection display of a projection image in which both sides in a horizontal direction are black stripes is performed on a screen.

In addition, JP-A-2017-97107 discloses that, in the projector, when receiving a notification that the smartphone coupled to the projector is used in the vertical direction, an aspect ratio of an image displayed on the smartphone is maintained by performing control of rotating a DMD by 90 degrees.

JP-A-2017-97107 is an example of the related art.

However, in the related art, when the projector is a device that does not have a mechanism for rotating the DMD by 90 degrees, the projection display of the projection image in which both sides in the horizontal direction are black stripes is performed on the screen by the projector, and thus a display region cannot be used to the maximum.

### SUMMARY

According to an aspect of the embodiment, a display method includes: acquiring a master image; acquiring a first aspect ratio of a first display screen of a first display device; setting a first region in a master region of the master image based on the first aspect ratio; displaying, on the first display screen, a first image obtained by trimming an image portion inside the first region in the master image; acquiring a second aspect ratio of a second display screen of a second display device different from the first display device; setting, in the master region, a second region having an overlapping region that overlaps the first region and a non-overlapping region that does not overlap the first region in at least one of a first direction and a second direction that are orthogonal to each other in the master region, based on the second aspect ratio; and displaying, on the second display screen, a second image obtained by trimming an image portion inside the second region in the master image.

According to an aspect of the embodiment, display system includes: a first display device; and a second display device. The first display device acquires a master image, acquires a first aspect ratio of a first display screen of the first display device, sets a first region in a master region of the master image based on the first aspect ratio, and displays, on the first display screen, a first image obtained by trimming an image portion inside the first region in the master image, the first display device or the second display device acquires a second aspect ratio of a second display screen of a second display device, and sets, in the master region, a second region having an overlapping region that overlaps the first region and a non-overlapping region that does not overlap the first region in at least one of a first direction and a second direction that are orthogonal to each other in the master region, based on the second aspect ratio, and the second display device displays, on the second display screen, a second image obtained by trimming an image portion inside the second region in the master image.

### BRIEF DESCRIPTION OF THE DRAWINGS

FIG. 1 is a diagram showing a schematic configuration example of a display system according to an embodiment.

FIG. 2 is a diagram showing a schematic configuration example of a first display device according to an embodiment.

FIG. 3 is a diagram showing a schematic configuration example of a second display device according to the embodiment.

FIG. 4 is a diagram showing a schematic configuration example of a third display device according to the embodiment.

FIG. 5 is a diagram showing a schematic configuration example of a server device according to an embodiment.

FIG. 6 is a diagram showing an example of map information stored in the server device according to the embodiment.

FIG. 7 is a diagram showing a configuration example of a master layer in the first display device according to the embodiment.

FIG. 8A is a diagram showing an example of a first image displayed on a first display screen of the first display device according to the embodiment.

FIG. 8B is a diagram showing an example of a second image displayed on a second display screen of the second display device according to the embodiment.

FIG. 9 is a diagram showing an example of a procedure of processing performed in image display on the first display device according to the embodiment.

FIG. 10A is a diagram showing an example of a configuration of a master region before change according to the embodiment.

FIG. 10B is a diagram showing an example of a configuration of the master region after the change according to the embodiment.

FIG. 11A is a diagram showing an example of a configuration of the master region before change according to the embodiment.

FIG. 11B is a diagram showing an example of a configuration of the master region after the change according to the embodiment.

FIG. 12 is a diagram showing an example of a configuration of the master region according to the embodiment.

FIG. 13 is a diagram showing an example of a configuration of the master region according to the embodiment.

FIG. 14A is a diagram showing an example of a configuration of the master region according to the embodiment.

FIG. 14B is a diagram showing an example of a configuration of the master region according to the embodiment.

FIG. 15A is a diagram showing an example of a center of a region according to the embodiment.

FIG. 15B is a diagram showing an example of the center of the region according to the embodiment.

FIG. 15C is a diagram showing an example of the center of the region according to the embodiment.

FIG. 16 is a diagram showing an example of screen sharing according to the background art.

### DESCRIPTION OF EMBODIMENTS

An embodiment will now be described with reference to the drawings.

In the following description, dimensions of regions and the like illustrated in the drawings are examples for description, and are not necessarily strict dimensions, and are not necessarily limited to the illustrated dimensions.

In addition, in the drawings, when two or more overlapping line segments are illustrated, these line segments may be slightly shifted in order to make these line segments easy to see.

In addition, in the following description, a number, an alphabet, or a combination thereof may be added to a name of a component such as first or second, but this is for convenience of description and is not intended to limit disclosure contents to unnecessary.

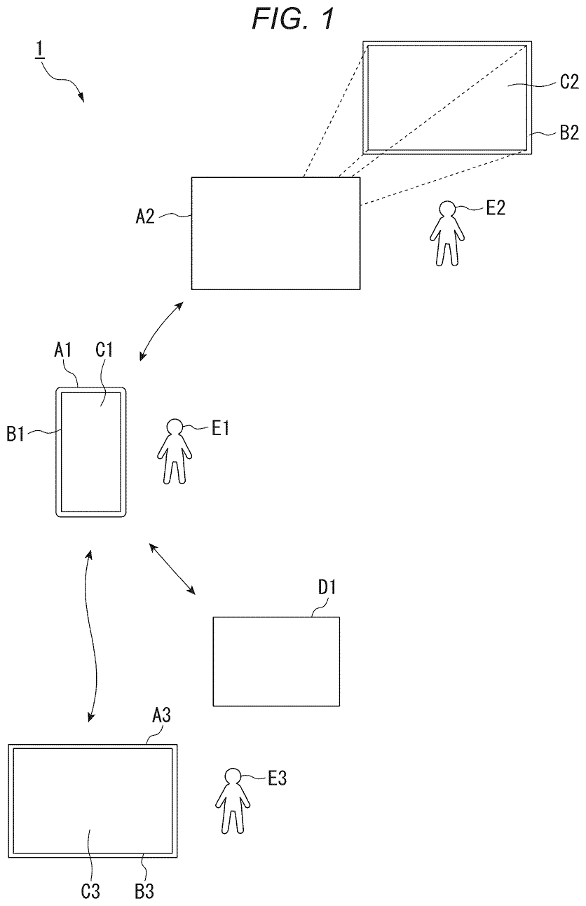

FIG. 1 is a diagram showing a schematic configuration example of a display system 1 according to an embodiment.

The display system 1 includes a first display device A1, a second display device A2, a third display device A3, and a server device D1.

FIG. 1 shows a first user E1 who operates the first display device A1, a second user E2 who operates the second display device A2, and a third user E3 who operates the third display device A3.

Here, in the embodiment, the server device D1 is described as being provided in the display system 1, but as another example, the server device D1 may be regarded as a device outside the display system 1.

In the embodiment, the display system 1 includes three display devices, but as another example, a display system having two display devices may be implemented, or a display system having four or more display devices may be implemented.

In the embodiment, the first display device A1 and the server device D1 communicate with each other by wire, wirelessly, or both.

In the embodiment, the first display device A1 and the second display device A2 communicate with each other by wire, wirelessly, or both.

In the embodiment, the first display device A1 and the third display device A3 communicate with each other by wire, wirelessly, or both.

In the embodiment, as a specific example, the first display device A1 is a smartphone, the second display device A2 is a projector, and the third display device A3 is a tablet terminal.

In the embodiment, the display system 1 including the first display device A1 to the third display device A3 is shown to describe a combination of the first display device A1, which is a smartphone as an example of a mobile terminal, and the second display device A2, which is a projector, and a combination of the first display device A1, which is a smartphone, and the third display device A3, which is a tablet terminal.

As another example, a display system including the first display device A1 as a smartphone and the second display device A2 as a projector may be implemented separately for each combination, or a display system including the first display device A1 as a smartphone and the third display device A3 as a tablet terminal may be implemented.

In the embodiment, a case in which each display device is operated by each user is shown, but as another example, two users among the first user E1 to the third user E3 may be common, or all the three users may be common.

For example, one or more display devices may automatically execute processing a according to predetermined processing procedure without being operated by the user.

The first display device A1 includes a first display screen B1. In the example of FIG. 1, a first image C1 is displayed on the first display screen B1.

The second display device A2 includes a second display screen B2. In the example of FIG. 1, a second image C2 is displayed on the second display screen B2. Here, in the embodiment, the second display device A2 is a projector, the second display screen B2 is a screen, and the second image C2 is an image projected on the screen.

For example, the present disclosure may be applied to a case in which an image projected on the screen is viewed by a plurality of people in a predetermined room or the like.

The third display device A3 includes a third display screen B3. In the example of FIG. 1, a third image C3 is displayed on the third display screen B3.

In the embodiment, the image displayed on a display screen may be an image of any display content, and may be, for example, an image representing a map, a sentence, a figure, a still image, a video, or a combination of two or more thereof.

Instead of the image, the image may be referred to as a video.

Here, a specific example of each display device is an example, and various devices may be used as each display device.

For example, a display device of a car navigation system or a display device of an electronic blackboard system may be used as the second display device A2 or the third display device A3.

For example, as the second display device A2 or the third display device A3, a display device having a screen and having a function of displaying an image input from the outside on the screen may be used.

The second display screen B2 of the second display device A2 and the third display screen B3 of the third display device A3 may be regarded as external monitors capable of screen sharing with respect to the first display screen B1 of the first display device A1.

The screen sharing may be referred to as, for example, image sharing.

The display device may be referred to as, for example, an information processing device.

The server device D1 may be, for example, a cloud device.

In the embodiment, the first display device A1 communicates with the server device D1, but as another example, the second display device A2 or the third display device A3, or two or more display devices may communicate with the server device D1.

In the embodiment, in screen sharing, the first display device A1 is used as a transmitter, and the second display device A2 or the third display device A3 is used as a receiver.

Schematically, the first display device A1, which is the transmitter, acquires image information from the server device D1 and displays an image based on the image information on its own screen. The first display device A1 transmits an image based on the image information to the receiver as necessary. The second display device A2 or the third display device A3, which is the receiver, displays the image on its own screen.

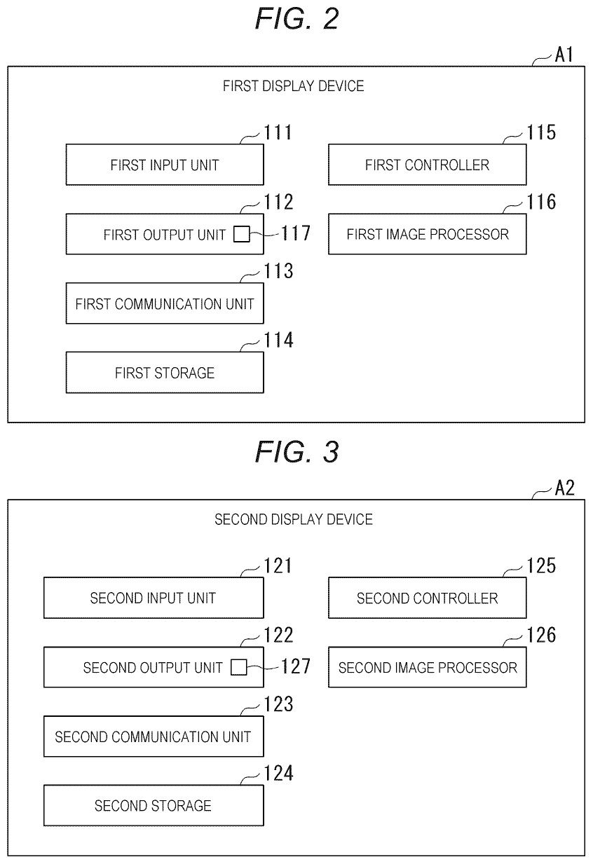

FIG. 2 is a diagram showing a schematic configuration example of the first display device A1 according to the embodiment.

The first display device A1 includes a first input unit 111, a first output 112, a first communication unit 113, a first storage 114, a first controller 115, and a first image processor 116.

The first output unit 112 includes a first display 117.

The first input unit 111 inputs information corresponding to an operation performed by the first user E1.

The first input unit 111 may input, for example, information output from an external device connected using a coupling terminal.

The first output unit 112 displays and outputs information on the first display screen B1 by the first display 117. The first output unit 112 may output a sound together with the display of the image.

For example, the first output unit 112 may output information to an external device coupled using a coupling terminal.

Here, the first input unit 111 and the first display 117 may be implemented using, for example, a touch panel.

The first communication unit 113 communicates with an external device. In the embodiment, the external device is the second display device A2, the third display device A3, or the server device D1.

The first storage 114 stores various information.

The first controller 115 performs various types of processing and control in the first display device A1.

In the embodiment, the first display device A1 is implemented using a computer. The first controller 115 includes a processor such as a central processor (CPU) and performs various types of processing and control b executing a predetermined program by the processor.

The first image processor 116 performs various types of image processing. In the embodiment, for example, the first image processor 116 is controlled by the first controller 115 to perform various types of image processing.

Here, for example, the first display 117 displays and outputs an image processed by the first image processor 116.

FIG. 3 is a diagram showing a schematic configuration example of the second display device A2 according to the embodiment.

The second display device A2 includes a second input unit 121, a second output unit 122, a second communication unit 123, a second storage 124, a second controller 125, and a second image processor 126.

The second output unit 122 includes a second display 127.

The second input unit 121 inputs information corresponding to an operation performed by the second user E2. Here, the second input unit 121 may be implemented using, for example, a key or a touch panel.

The second output unit 122 displays and outputs information on the second display screen B2 by the second display 127. The second output unit 122 may output a sound together with the display of the image.

The second communication unit 123 communicates with an external device. In the embodiment, the external device is the first display device A1.

The second storage 124 stores various information.

The second controller 125 performs various types of processing and control in the second display device A2.

In the embodiment, the second display device A2 includes a control computer. The second controller 125 includes a processor such as a CPU, and performs various types of processing and control by executing a predetermined program by the processor.

The second image processor 126 performs various types of image processing.

Here, in the embodiment, the second display device A2 is a projector.

The second image processor 126 includes, for example, a predetermined optical system and processes an image to be projected on the screen.

For example, the second display 127 outputs the image processed by the second image processor 126 to be displayed on the screen.

In the embodiment, for convenience of description, the second image processor 126 and the second display 127 are distinguished from each other, but for example, the second image processor 126 and the second display 127 may be integrated.

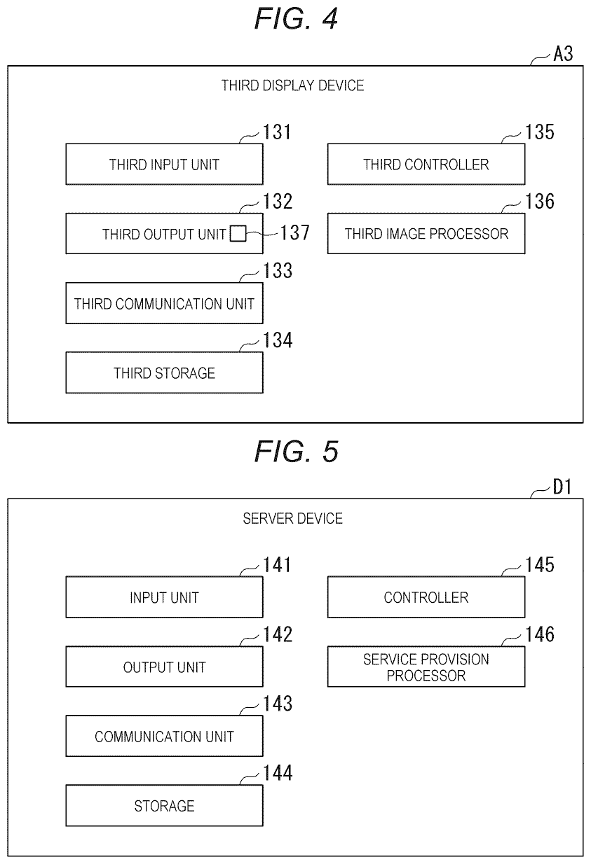

FIG. 4 is a diagram showing a schematic configuration example of the third display device A3 according to the embodiment.

The third display device A3 includes a third a third output unit 132, a third input unit 131, communication unit 133, a third storage 134, a third controller 135, and a third image processor 136.

The third output unit 132 includes third display 137.

The third input unit 131 inputs information corresponding to an operation performed by the third user E3.

The third input unit 131 may receive, for example, information output from an external device coupled using a coupling terminal.

The third output unit 132 displays and outputs information on the third display screen B3 by the third display 137. The third output unit 132 may output a sound together with the display of the image.

For example, the third output unit 132 may output information to an external device coupled using a coupling terminal.

Here, the third input unit 131 and the third display 137 may be implemented using, for example, a touch panel.

The third communication unit 133 communicates with an external device. In the embodiment, the external device is the first display device A1.

The third storage 134 stores various information.

The third controller 135 performs various types of processing and control in the third display device A3.

In the embodiment, the third display device A3 is implemented using a computer. The third controller 135 includes a processor such as a CPU, and performs various types of processing and control by executing a predetermined program by the processor.

The third image processor 136 performs various types of image processing. In the embodiment, for example, the third image processor 136 is controlled by the third controller 135 to perform various types of image processing.

Here, the third display 137 displays and outputs, for example, the image processed by the third image processor 136.

FIG. 5 is a diagram showing a schematic configuration example of the server device D1 according to the embodiment.

The server device D1 includes an input unit 141, an output unit 142, a communication unit 143, a storage 144, a controller 145, and a service provision processor 146.

The input unit 141 inputs information according to an operation performed by an operator (not shown).

The output unit 142 outputs information by display output, sound output, or the like.

The communication unit 143 communicates with an external device. In the embodiment, the external device is the first display device A1.

The storage 144 stores various information.

The controller 145 performs various types of processing and control in the server device D1.

In the embodiment, the server device D1 is implemented using a computer. The controller 145 includes a processor such as a CPU, and performs various types of processing and control by executing a predetermined program by the processor.

The service provision processor 146 performs processing for providing a predetermined service. In the embodiment, for example, the service provision processor 146 is controlled by the controller 145 to perform various types of image processing.

Here, in the embodiment, a case in which the service provision processor 146 of the server device D1 performs a service of providing predetermined map information will be described.

The map information is stored in, for example, the storage 144. As another example, the map information may be stored in a database or the like (not shown) provided outside the server device D1, and in this case, the server device D1 acquires the map information from the database or the like.

The information provided by the server device D1 is not particularly limited, and any other information may be used.

Here, in the embodiment, a case in which the server device D1 is operated by the operator is shown. However, for example, the server device D1 may be remotely operated by the operator.

As another example, the server device D1 may automatically perform predetermined processing without being operated by the operator.

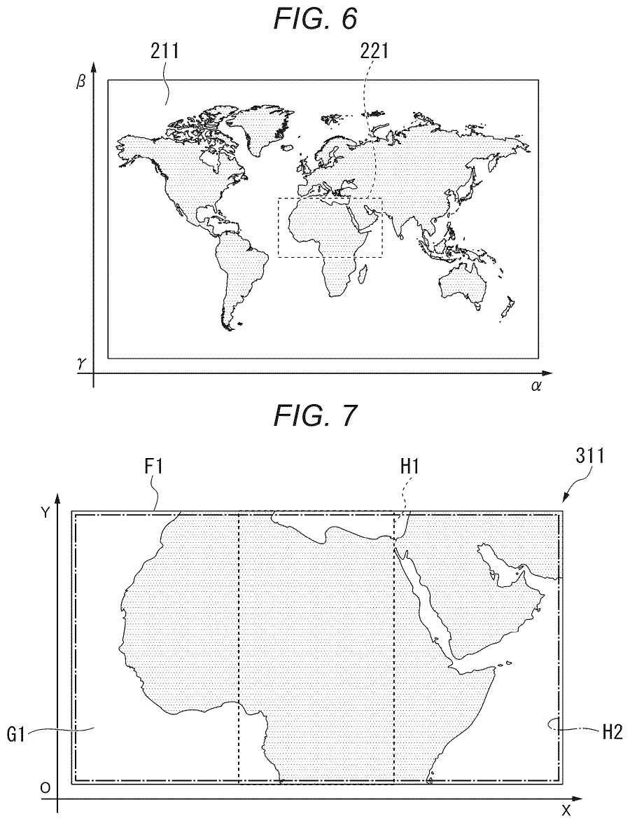

FIG. 6 is a diagram showing an example of map information 211 stored in the server device D1 according to the embodiment.

The map information 211 is, for example, information of a world map.

FIG. 6 shows an αβ orthogonal coordinate system, which is a two-dimensional orthogonal coordinate system, for convenience of description. In the αβ orthogonal coordinate system, an origin γ, an α axis, and a β axis are shown. In the embodiment, an α direction parallel to the α axis corresponds to a so-called horizontal direction, and a β direction parallel to the β axis corresponds to a so-called vertical direction.

FIG. 6 shows an example of the provision range 221 set in the map information 211.

The provision range 221 represents a range of an information portion provided to a provision destination by the service provision processor 146 in the entire map information 211.

In the embodiment, the provision destination is the first display device A1.

In the embodiment, the first display device A1 transmits request information to the server device D1 on a WEB site provided by the server device D1.

The service provision processor 146 of the server device D1 determines the provision range 221 based on the request information received from the first display device A1.

Then, the service provision processor 146 of the server device D1 transmits an information portion included in the determined provision range 221 in the map information 211 to the first display device A1.

Here, the first display device A1 changes the request information and transmits the request information to the server device D1 as necessary. By changing the request information from the first display device A1, the provision range 221 in the server device D1 is changed, and the information transmitted from the server device D1 to the first display device A1 is changed.

Screen sharing in a combination of the first display device A1 and the second display device A2 will be described with reference to FIGS. 7, 8A, 8B, and 9. In the embodiment, the first display device A1 is a main device, and the second display device A2 is a sub device.

FIG. 7 is a diagram showing a configuration example of a master layer 311 in the first display device A1 according to the embodiment.

FIG. 7 shows an XY orthogonal coordinate system, which is a two-dimensional orthogonal coordinate system, for convenience of description. In the XY orthogonal coordinate system, an origin O, an X axis, and a Y axis are shown.

In the embodiment, an X direction parallel to the X axis corresponds to a so-called horizontal direction, a positive side corresponds to the right side, and a negative side corresponds to the left side. In the embodiment, a Y direction parallel to the Y axis corresponds to a so-called vertical direction, a positive side corresponds to the upper side, and a negative side corresponds to the lower side. The horizontal direction and the vertical direction may be reversed.

Here, in the embodiment, the X direction and the Y direction in the XY orthogonal coordinate system are respectively parallel to the α direction and the β direction in the αβ orthogonal coordinate system shown in FIG. 6, but as another example, the X direction and the Y direction in the XY orthogonal coordinate system may be associated with the α direction and the β direction in the αβ orthogonal coordinate system shown in FIG. 6 in another aspect.

In the first display device A1, the first image processor 116 draws the master image on the master layer 311.

In the embodiment, a region of the master image is referred to as a master region.

In the example of FIG. 7, a first master image G1 is shown as the master image drawn on the master layer 311.

In the example of FIG. 7, a first master region F1 is shown as the master region of the first master image G1.

Here, the master layer 311 may be, for example, a predetermined region provided in a recording region of the first storage 114. In this case, processing of drawing the master image in the master layer 311 may be processing of storing data of the master image in the master layer 311 and storing the master image.

In this case, for example, the master layer 311 and the first master region F1 may be regarded as to be substantially the same.

In the example of FIG. 7, the first master region F1 is a rectangular region surrounded by two line segments in the X direction parallel to the X axis and two line segments in the Y direction parallel to the Y axis. A square may be included as a type of rectangle.

In the example, the first image processor 116 of the first display device A1 transmits the request information to the server device D1 to acquire the information portion of the provision range 221 based on the request information from the t server device D1. The information portion corresponds to the map information of the provision range 221. Then, the first image processor 116 of the first display device A1 draws the acquired map information on the master layer 311 as the first master image G1.

Here, in the embodiment, the request information includes information indicating a reference point and information indicating an aspect ratio.

The reference point is a point serving as a reference for setting the provision range 221 in the map information 211 in the server device D1, and may be, for example, a point serving as a center position of the provision range 221 in the map information 211.

The aspect ratio is used as a value for setting a frame of the provision range 221 with reference to the reference point.

Such information indicating the reference point may be regarded as coordinate information indicating coordinates of the content. Such a combination of the reference point and the aspect ratio may also be regarded as the coordinate information representing the coordinates and the range of the content. That is, the request information may be regarded as information including the coordinate information of the content.

The service provision processor 146 of the server device D1 determines and sets the provision range 221 suitable for the reference point and the aspect ratio designated by the request information from the first display device A1.

In the example, when one or both of the reference point and the aspect ratio identified by the request information change, the provision range 221 may change.

In the embodiment, the first image processor 116 of the first display device A1 determines the aspect ratio to be included in the request information based on the aspect ratio of the first display screen B1 of the first display device A1 and the aspect ratio of the second display screen B2 of the second display device A2.

In the example of FIG. 7, the first image processor 116 of the first display device A1 uses the aspect ratio of the second display screen B2 of the second display device A2 as the aspect ratio to be included in the request information.

In the embodiment, the aspect ratio of the first display screen B1 of the first display device A1 is (16:9) in (Y direction:X direction), and a resolution is (1920:1080).

In the embodiment, the aspect ratio of the second display screen B2 of the second display device A2 is (9:16) in (Y direction:X direction) and (1080:1920) in resolution.

As described above, the aspect ratio of the first display screen B1 is different from the aspect ratio of the second display screen B2.

In the first display device A1, for example, the aspect ratio of the first display screen B1 is stored in the first storage 114 in advance.

In the first display device A1, for example, the aspect ratio of the second display screen B2 of the second display device A2 may be stored in advance in the first storage 114, or information identifying the aspect ratio of the second display screen B2 of the second display device A2 may be acquired from the second display device A2 or another device. The another device may be the server device D1.

In the first display device A1, for example, the aspect ratio of the second display screen B2 of the second display device A2 may be acquired from the second display device A2 or another device in real time during the screen sharing or the like.

In the example of FIG. 7, the first image processor 116 of the first display device A1 sets a first region H1 matching the aspect ratio of the first display screen B1 of the first display device A1 in the first master region F1. Then, the first image processor 116 of the first display device A1 trims the image portion provided in the first region H1 and displays and outputs the trimmed image portion on the first display screen B1.

In the example of FIG. 7, the first image processor 116 of the first display device A1 sets a second region H2 matching the aspect ratio of the second display screen B2 of the second display device A2 in the first master region F1. Then, the first image processor 116 of the first display device A1 trims the image portion provided in the second region H2 and transmits the trimmed image portion to the second display device A2. Accordingly, the second image processor 126 of the second display device A2 displays and outputs the image portion on the second display screen B2.

The trimming may be referred to as, for example, cutting out.

Here, the first region H1 may be associated with the master layer 311, the first master region F1, or the like using, for example, the coordinates in the XY orthogonal coordinate system.

The second region H2 may be associated with the master layer 311, the first master region F1, or the like using, for example, the coordinates in the XY orthogonal coordinate system.

The first region H1 and the second region H2 may be associated with each other using, for example, the coordinates in the XY orthogonal coordinate system, or may be associated with each other using a relative positional relationship.

In the example of FIG. 7, the second region H2 overlaps the first master region F1, but for convenience of description, the second region H2 and the first master region F1 are slightly shifted from each other for easy viewing.

In the example of FIG. 7, an upper side and a lower side, which are parts of the first region H1, overlap the first master region F1.

In the embodiment, the second region H2 has an overlapping region that overlaps the first region H1.

In the embodiment, the second region H2 has a non-overlapping region that is a region not overlapping the first region H1 in the X direction, the Y direction, or both the X direction and the Y direction. That is, the second region H2 protrudes from the first region H1 in the X direction, the Y direction, or both the X direction and the Y direction.

In the embodiment, a case in which the first master region F1 and the second region H2 coincide with each other is shown, and an aspect in which the first master region F1 and the second region H2 do not coincide may be used.

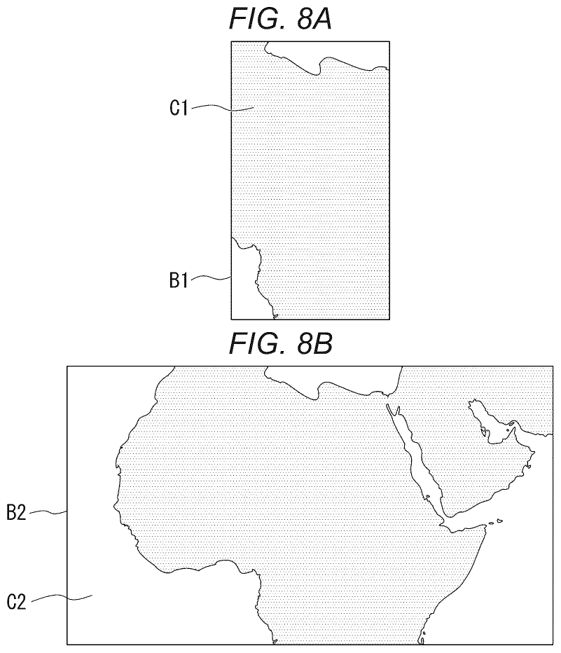

FIG. 8A is a diagram showing an example of the first image C1 displayed on the first display screen B1 of the first display device A1 according to the embodiment.

FIG. 8B is a diagram showing an example of the second image C2 displayed on the second display screen B2 of the second display device A2 according to the embodiment.

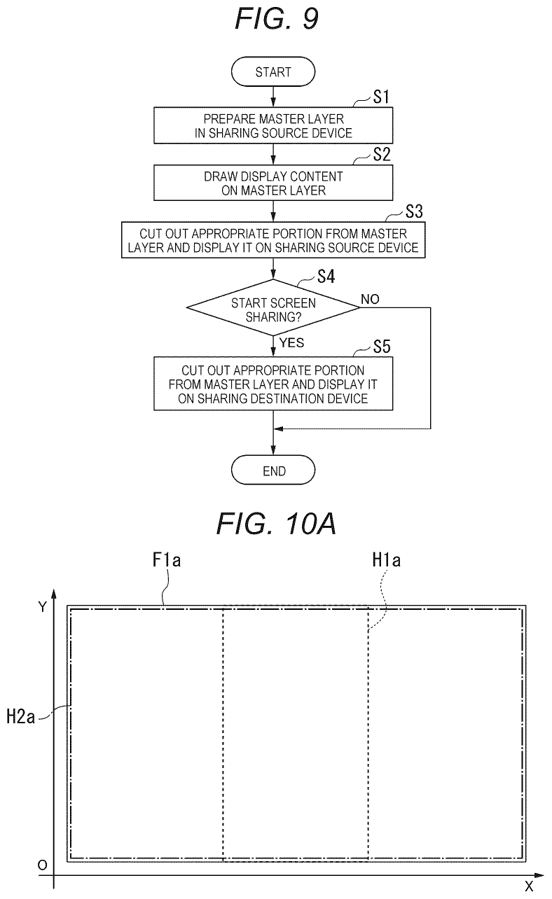

FIG. 9 is a diagram showing an example of a procedure of processing performed in image display in the first display device A1 according to the embodiment.

In the example, the transmitter is the first display device A1, and the receiver is the second display device A2.

In this example, the screen sharing is switched on and off in the first display device A1. The switching may be performed, for example, by the first user E1 operating the first display device A1, or may be automatically performed according to a predetermined switching condition.

In step S1, in the first display device A1 which is the transmitter, the first image processor 116 prepares the master layer 311.

Next, in step S2, in the first display device A1, the first image processor 116 draws a display content on the master layer 311. In the example, the display content is the first master image G1.

Next, in step S3, in the first display device A1, the first image processor 116 cuts out an appropriate portion from the master layer 311 and displays an image of the portion on the first display screen B1.

In the example, the appropriate portion is a portion of the first region H1. The appropriate portion is cut out by trimming.

Next, in step S4, in the first display device A1, the first image processor 116 determines whether to start the screen sharing.

In the example, the first image processor 116 determines to start the screen sharing when the screen sharing is already set to ON or when the screen sharing is switched from OFF to ON in real time. On the other hand, when the screen sharing is set to OFF, the first image processor 116 determines not to start the screen sharing.

In the determination of step S4, in the first display device A1, when the first image processor 116 determines to start the screen sharing, YES is determined in step S4, and the processing proceeds to step S5.

On the other hand, in the determination of step S4, in the first display device A1, when the first image processor 116 determines not to start the screen sharing, NO is determined in step S4, and the processing of the flow ends.

In step S5, in the first display device A1, the first image processor 116 performs processing for cutting out the appropriate portion from the master layer 311 and displaying an image of the portion on the second display screen B2 of the second display device A2 which is the receiver. The processing of the flow ends.

In the example, the appropriate portion is a portion of the second region H2. The appropriate portion is cut out by trimming.

As a specific example, when the first user E1 is viewing the first image C1 displayed on the first display screen B1 of the first display device A1, the second user E2 can view the second image C2 displayed on the second display screen B2 of the second display device A2. For example, a size of the second display screen B2 of the second display device A2 is larger than a size of the first display screen B1 of the first display device A1, and a plurality of users can simultaneously view the second image C2.

For example, when the first user E1 operates the first display device A1 to give an instruction to shift the reference point of the first region H1, the updated request information in which the reference point is shifted is transmitted from the first display device A1 to the server device D1. Accordingly, the provision range 221 in the server device D1 is updated, and the image portion transmitted from the server device D1 to the first display device A1 is updated. Then, the first master image G1 in the first display device A1 is updated, the image content of the first image C1 is updated, and the image content of the second image C2 is updated.

As an example, when the reference point of the map information displayed on the first display screen B1 is shifted, the map information displayed on the first display screen B1 is scrolled accordingly, and the map information displayed on the second display screen B2 is scrolled in synchronization therewith.

As described above, in a display method and the display system 1 according to the embodiment, the first master image G1 of the first master region F1 is set based on the aspect ratio of the first display screen B1 of the first display device A1 and the aspect ratio of the second display screen B2 of the second display device A2.

Then, the first image C1 of the first region H1 corresponding to the aspect ratio of the first display screen B1 is generated and displayed on the first display device A1.

The second image C2 of the second region H2 corresponding to the aspect ratio of the second display screen B2 is generated and displayed on the second display device A2.

Therefore, in the display method and the display system 1 according to the embodiment, it is possible to optimally display the display content on the display screen of each display device.

Here, in the example of FIG. 7, the first region H1 in the first master region F1 is a region that can be displayed to the maximum when the aspect ratio of the first display screen B1 is used.

In the example of FIG. 7, the second region H2 in the first master region F1 is a region that can be displayed to the maximum when the aspect ratio of the second display screen B2 is used.

As described above, in the display method and the display system 1 according to the embodiment, even when the aspect ratios of the display screens are different from each other, it is possible to eliminate a useless space when images are displayed on these display screens. The useless space is, for example, a black stripe portion in an example in the related art.

Here, the effect of the screen sharing in the embodiment will be described by comparison with an example in the related art.

In the screen sharing system according to the example in the related art, the display content of the screen of the transmitter is generally copied as it is to the screen of another receiver. In this case, in a configuration in which the aspect ratio of the sharing source and the aspect ratio of the sharing destination are different, a margin is generated in the display image of the sharing destination, and the margin becomes, for example, a black stripe portion (for example, see JP-A-2017-97107).

In the related art, software-controlled automatic scaling or trimming is generally performed as a method for preventing a margin from being generated during the screen sharing.

However, the automatic scaling has a problem that screen distortion occurs or inappropriate scaling is performed.

In addition, during trimming, since the trimming is performed from the screen of the transmitter, information at an end of the screen may be lost.

Here, a specific example of the screen sharing according to the background art will be described with reference to FIG. 16.

FIG. 16 is a diagram showing an example of the screen sharing according to the background art.

FIG. 16 shows an example of a sharing source image 1011 displayed on the screen of the transmitter and an example of a sharing destination image 1021 displayed on the screen of the receiver.

In the example of FIG. 16, for convenience of description, although a cutout region 1111 in the sharing source image 1011 is shown, the cutout region 1111 is used in internal processing of the transmitter but is not displayed on the screen.

In the example of FIG. 16, the cutout region 1111 is set in a central portion excluding an upper region and a lower region of the sharing source image 1011. An image of a portion provided in the cutout region 1111 in the sharing source image 1011 is the sharing destination image 1021, but information of the upper region and the lower region is lost.

In the example of FIG. 16, a left side and a right side, which are parts of the cutout region 1111, overlap the region of the sharing source image 1011.

Therefore, in the embodiment, a master region of a master image drawn in the master layer is optimized for the screen sharing between two devices having screens with different aspect ratios. In the embodiment, the master region is designed to cover a widest image range when the screen sharing is performed between these two devices.

When the screen sharing is performed, a transmitter serving as a transmission side cuts out an appropriate portion from the master layer based on its own aspect ratio, and displays the cutout portion on the screen. When the screen sharing is performed, the transmitter serving as the transmission side cuts out an appropriate portion from the master layer based on the aspect ratio of the receiver serving as a reception side, and transmits the cutout portion to the receiver. Accordingly, the receiver can receive the display content optimized for its own aspect ratio.

Therefore, in the embodiment, when the screen sharing is performed between two devices having screens of different aspect ratios, information loss can be reduced and a margin can be eliminated as compared with the related art.

The embodiment is particularly effective for a display content whose aspect ratio is not fixed, for example.

Here, in the embodiment, a case in which the first master image G1 is changed by changing the request information transmitted from the first display device A1 to the server device D1 when a predetermined event occurs in the first display device A1 is described. The event is, for example, that the first user E1 performs a predetermined operation such as scrolling on the first display device A1 or that a predetermined automatic operation such as scrolling occurs in the first display device A1.

As another example, when a predetermined event occurs in the second display device A2, the second display device A2 may notify the first display device A1 of the occurrence of the event, and in response to this, the first display device A1 may change the request information transmitted to the server device D1, thereby changing the first master image G1. The event is, for example, that the second user E2 performs a predetermined operation such as scrolling on the second display device A2 or that a predetermined automatic operation such as scrolling occurs in the second display device A2. In this case, the notification from the second display device A2 to the first display device A1 is performed by transmitting predetermined information from the second display device A2 to the first display device A1.

In the embodiment, when the first display device A1 shares the screen with the second display device A2, the first display device A1 generates an image suitable for the aspect ratio of the second display screen B2 of the second display device A2 based on the first master image G1 and transmits the generated image to the second display device A2.

As another example, when the first display device A1 shares the screen with the second display device A2, the first display device A1 may transmit an image corresponding to the first master image G1 to the second display device A2, generate an image suitable for the aspect ratio of the second display screen B2 based on the image received by the second display device A2, and display the generated image. The generation processing includes, for example, setting of the second region H2 and trimming.

The first display device A1 stores the aspect ratio of the first display screen B1 in the first storage 114 or the like, and the second display device A2 stores the aspect ratio of the second display screen B2 in the second storage 124 or the like.

In the embodiment, the first display device A1 acquires the first master image G1 based on the information received from the server device D1.

As another example, information serving as a source for generating the first master image G1 may be stored in a predetermined database, and the first display device A1 may acquire the first master image G1 based on the information.

As another example, information serving as a source for generating the first master image G1 may be stored in the first storage 114 of the first display device A1, and the first display device A1 may acquire the first master image G1 based on the information.

Although the screen sharing in the combination of the first display device A1 and the second display device A2 is described above, similar screen sharing may be applied to the combination of the first display device A1 and the third display device A3. In this case, for example, the first display device A1 is the main device, and the third display device A3 is the sub device.

Schematically, similar operations are performed by the third display device A3 and the third user E3 instead of the second display device A2 and the second user E2. However, in the embodiment, the second display device A2 is a projector, whereas the third display device A3 is a tablet terminal, and the operations may differ with respect to such differences.

Further, a configuration example of the display method and the display system 1 according to the embodiment will be described.

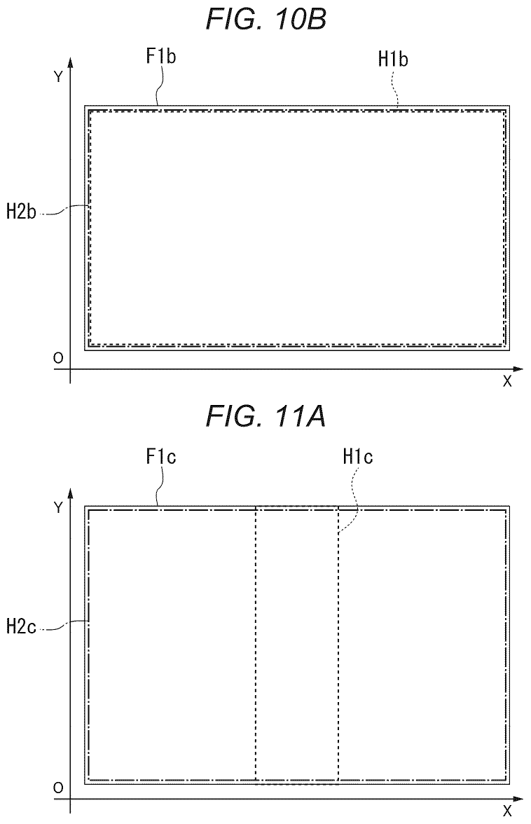

A change in the master region according to the rotation of the screen of the transmitter will be described with reference to FIGS. 10A and 10B.

FIG. 10A is a diagram showing an example of a configuration of the master region before change according to the embodiment.

FIG. 10B is a diagram showing an example of a configuration of the master region after the change according to the embodiment.

In FIGS. 10A and 10B, for convenience of description, the XY orthogonal coordinate system is shown as in the case of FIG. 7.

FIG. 10A shows a 1a master region F1a in the transmitter, a 1a region H1a corresponding to the screen of the transmitter, and a 2a region H2a corresponding to the screen of the receiver. The 1a master region F1a, the 1a region H1a, and the 2a region H2a in the example of FIG. 10A are similar to, for example, the first master region F1, the first region H1, and the second region H2 shown in FIG. 7.

In the example of FIG. 10A, similarly to the example of FIG. 7, the 2a region H2a overlaps the 1a master region F1a, but for convenience of description, the 2a region H2a and the 1a master region are slightly shifted from each other for easy viewing.

In the example of FIG. 10A, an upper side and a lower side, which are parts of the 1a region H1a, overlap the 1a master region Fla.

FIG. 10B shows a 1b master region Fb in the transmitter, a 1b region H1b corresponding to the screen of the transmitter, and a 2b region H2b corresponding to the screen of the receiver.

In the example of FIG. 10B, the 1b region H1b and the 2b region H2b overlap the 1b master region F1b, but for convenience of description, the 1b region H1b and the 2b region H2b and the 1b master region F1b are slightly shifted from each other for easy viewing.

For example, it is assumed that the transmitter is the first display device A1, which is a smartphone, and has a screen rotation function.

The first image processor 116 of the first display device A1 has a screen rotation function of rotating the first image C1 displayed on the first display screen B1 according to an operation of the first user E1. The operation may be, for example, an operation of inputting a predetermined instruction through a touch panel, or an operation of changing a posture of a housing of the first display device A1 to rotate the housing in a predetermined rotation direction.

The screen rotation function has, for example, a function of switching display of four types of images rotated at rotation angles of 90 degrees such as 0 degree, 90 degrees, 180 degrees, and 270 degrees with a center point of the first image C1 as a reference point.

As a specific example, it is assumed that a so-called vertically long image is displayed on the first display device A1 which is the transmitter, and the configuration of the 1a master region F1a shown in FIG. 10A is used.

At this time, in the first display device A1, when the screen is rotated by 90 degrees and a so-called horizontally long image is displayed, switching is performed so that the configuration of the 1b master region F1b shown in FIG. 10B is used.

This switching is performed by, for example, the first image processor 116. When switching from the configuration of the 1a master region Fla to the configuration of the 1b master region F1b, the first image processor 116 accesses the server device D1 and updates the master image as necessary. Here, when the vertically long image and the horizontally long image are rectangles other than squares, an aspect ratio of the vertically long image and an aspect ratio of the horizontally long image are different, and the master image is updated.

Similarly, in the first display device A1, when the display is switched from the display of the horizontally long image to the display of the vertically long image, the first image processor 116 accesses the server device D1 and updates the master image as necessary when switching from the configuration of the 1b master region F1b to the configuration of the 1a master region F1a.

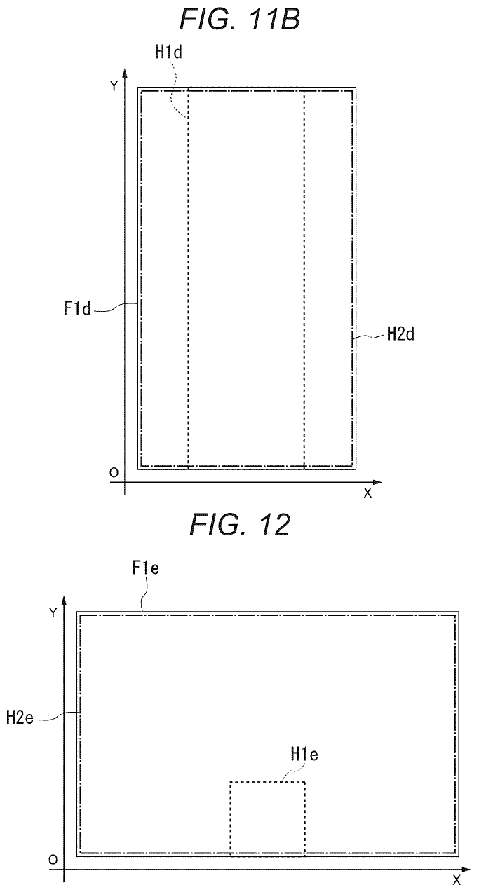

A change in the master region according to the rotation of the screen of the receiver will be described with reference to FIGS. 11A and 11B.

FIG. 11A is a diagram showing an example of the configuration of the master region before change according to the embodiment.

FIG. 11B is a diagram showing an example of the configuration of region after the change according to the embodiment.

In FIGS. 11A and 11B, for convenience of description, the XY orthogonal coordinate system is shown as in the case of FIG. 7.

FIG. 11A shows a 1c master region F1c in the transmitter, a 1c region H1c corresponding to the screen of the transmitter, and a 2c region H2c corresponding to the screen of the receiver.

In the example of FIG. 11A, the 2c region H2c overlaps the 1c master region F1c, but for convenience of description, the 2c region H2c and the 1c master region F1c are slightly shifted from each other for easy viewing.

In the example of FIG. 11A, an upper side and a lower side, which are parts of the 1c region H1c, overlap the 1c master region F1c.

FIG. 11B shows a 1d master region F1d in the transmitter, a 1d region H1d corresponding to the screen of the transmitter, and a 2d region H2d corresponding to the screen of the receiver.

In the example of FIG. 11B, the 2d region H2d overlaps the 1d master region F1d, but for convenience of description, the 2d region H2d and the 1d master region F1d are slightly shifted from each other for easy viewing.

In the example of FIG. 11B, an upper side and a lower side, which are parts of the 1d region H1d, overlap the 1d master region F1d.

Here, the examples of FIGS. 11A and 11B show a case in which the aspect ratio of at least one of the screen of the transmitter and the screen of the receiver is different from the corresponding g aspect ratio in the examples of FIGS. 10A and 10B.

The aspect ratio in the example is an example for showing a case different from the examples of FIGS. 10A and 10B.

For example, it is assumed that the receiver is the third display device A3, which is a tablet terminal, and has a screen rotation function.

The third image processor 136 of the third display device A3 has a screen rotation function of rotating the third image C3 displayed on the third display screen B3 according to an operation of the third user E3. The operation may be, for example, an operation of inputting a predetermined instruction through a touch panel, or an operation of changing a posture of a housing of the third display device A3 to rotate the housing in a predetermined rotation direction.

The screen rotation function has, for example, a function of switching display of four types of images rotated at rotation angles of 90 degrees such as 0 degree, 90 degrees, 180 degrees, and 270 degrees with a center point of the third image C3 as a reference point.

As a specific example, it is assumed that a so-called horizontally long image is displayed on the third display device A3 which is a receiver, and the configuration of the 1c master region F1c shown in FIG. 11A is used.

At this time, in the third display device A3, when the screen is rotated by 90 degrees and a so-called vertically long image is displayed, switching is performed so that the configuration of the 1d master region F1d shown in FIG. 11B is used.

For example, the third image processor 136 of the third display device A3 notifies the first image processor 116 of the first display device A1 of the switching, and the first image processor 116 performs the switching. When switching from the configuration of the 1c master region F1c to the configuration of the 1d master region F1d, the first image processor 116 accesses the server device D1 and updates the master image as necessary. Here, when the vertically long image and the horizontally long image are rectangles other than squares, an aspect ratio of the vertically long image and an aspect ratio of the horizontally long image are different, and the master image is updated.

Similarly, in the third display device A3, when the display is switched from the display of the vertically long image to the display of the horizontally long image, the first image processor 116 accesses the server device D1 and updates the master image as necessary when switching from the configuration of the 1d master region F1d to the configuration of the 1c master region F1c.

FIGS. 10A and 12 show an example in which the aspect ratio of the master region coincides with the aspect ratio of the screen of the receiver.

In the example of FIG. 10A, the aspect ratio of the 1a master region F1a coincides with the aspect ratio of the 2a region H2a.

FIG. 12 is a diagram showing an example of the configuration of the master region according to the embodiment.

In FIG. 12, for convenience of description, the XY orthogonal coordinate system is shown as in the case of FIG. 7.

FIG. 12 shows a 1e master region F1e in the transmitter, a 1e region H1e corresponding to the screen of the transmitter, and a 2e region H2e corresponding to the screen of the receiver.

In the example of FIG. 12, the 2e region H2e overlaps the 1e master region F1e, but for convenience of description, the 2e region H2e and the 1e master region F1e are slightly shifted from each other for easy viewing.

In the example of FIG. 12, a lower side, which is a part of the 1e region H1e, overlaps the 1e master region F1e.

Here, in the example of FIG. 12, the aspect ratio of the 1e master region F1e coincides with the aspect ratio of the 2e region H2e.

In the example of FIG. 12, the aspect ratio of the 1e region H1e is different from that in the example of FIG. 10A.

Referring to FIG. 10A, an example is shown in which a length of the first region in the vertical direction is greater than a length of the first region in the horizontal direction, and the length of the first region in the vertical direction coincides with the length of the second region in the vertical direction.

In the example of FIG. 10A, a length of the 1a region H1a in the vertical direction is greater than a length of the 1a region H1a in the horizontal direction.

In the example of FIG. 10A, the length of the 1a region H1a in the vertical direction coincides with the length of the 2a region H2a in the vertical direction.

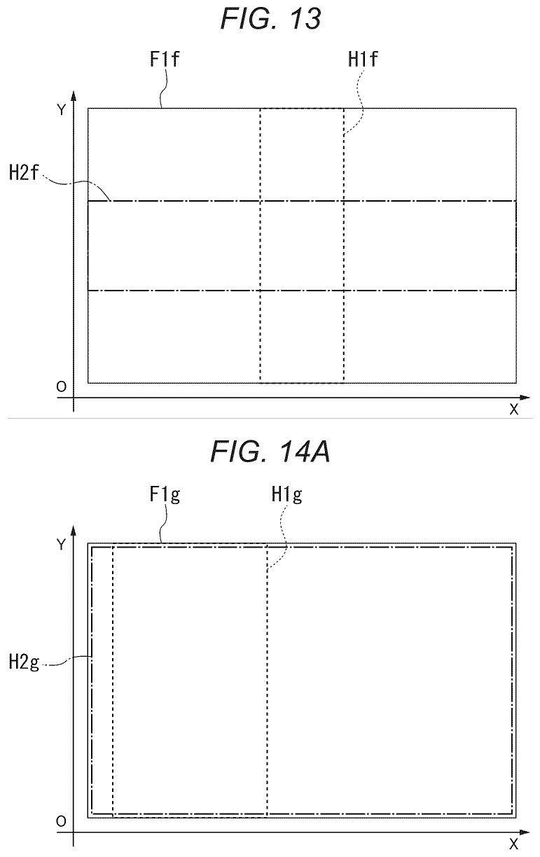

Referring to FIG. 13, an example is shown in which the length of the second region in the horizontal direction coincides with the length of the master region in the horizontal direction, and the length of the second region in the vertical direction is less than the length of the master region in the vertical direction.

FIG. 13 is a diagram showing an example of the configuration of the master region according to the embodiment.

In FIG. 13, for convenience of description, the XY orthogonal coordinate system is shown as in the case of FIG. 7.

FIG. 13 shows a 1f master region F1f in the transmitter, a 1f region H1f corresponding to the screen of the transmitter, and a 2f region H2f corresponding to the screen of the receiver.

In the example of FIG. 13, a length of the 2f region H2f in the horizontal direction coincides with a length of the 1f master region F1f in the horizontal direction.

In the example of FIG. 13, a length of the 2f region H2f in the vertical direction is less than a length of the 1f master region F1f in the vertical direction.

In the example of FIG. 13, an upper side and a lower side, which are parts of the 1f region H1f, overlap the 1f master region F1f.

In the example of FIG. 13, a left side and a right side, which are parts of the 2f region H2f, overlap the 1f master region F1f.

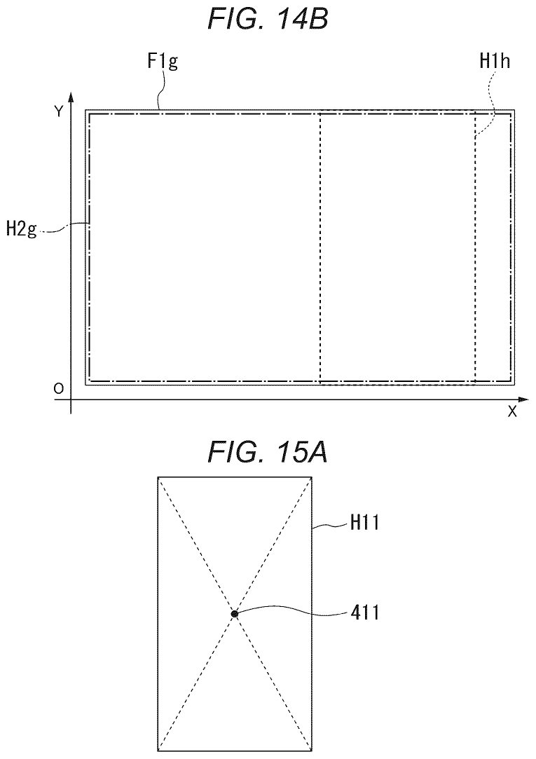

A case in which a center of the first region of the screen of the transmitter does not coincide with the center of the second region of the screen of the receiver will be described with reference to FIGS. 14A and 14B.

FIGS. 14A and 14B are diagrams each showing an example of the configuration of the master region according to the embodiment.

In FIGS. 14A and 14B, for convenience of description, the XY orthogonal coordinate system is shown as in the case of FIG. 7.

FIG. 14A shows a 1g master region F1g in the transmitter, a 1g region H1g corresponding to the screen of the transmitter, and a 2g region H2g corresponding to the screen of the receiver.

FIG. 14B shows a state in which the 1g region H1g is moved from the state shown in FIG. 14A. In the example of FIG. 14B, a 1h region H1h represents a region after the 1g region H1g shown in FIG. 14A is moved.

In the example of FIGS. 14A and 14B, the 2g region H2g overlaps the 1g master region F1g, but for convenience of description, the 2g region H2g and 1g master region F1g are slightly shifted from each other for easy viewing.

In the example of FIGS. 14A and 14B, an upper side and a lower side which are parts of the 1g region H1g and the upper side and the lower side which are parts of the 1h region H1h overlap the 1g master region F1g.

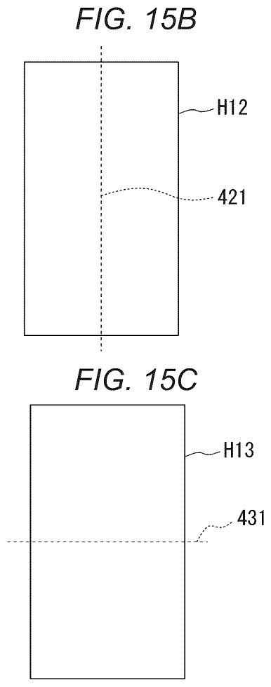

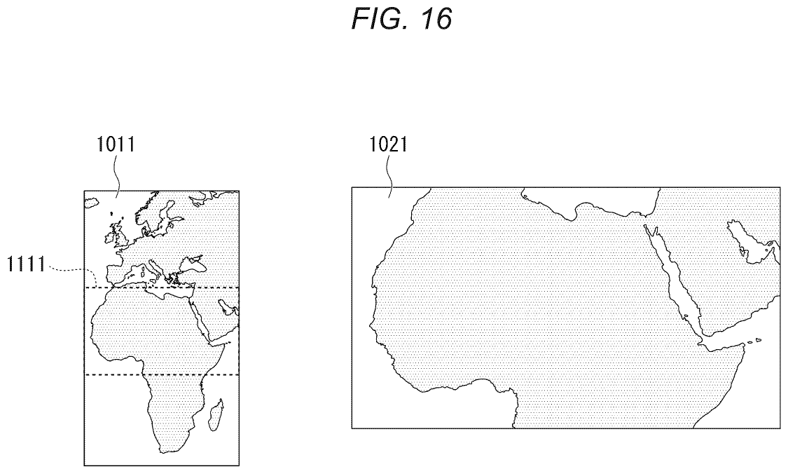

Here, an example of the center of the region will be described with reference to FIGS. 15A, 15B, and 15C.

FIG. 15A is a diagram showing an example of the center of the region according to the embodiment.

In the example of FIG. 15A, an intersection of two diagonal lines in a rectangular 11-th region H11 is defined as a first center point 411.

In FIG. 15A, for convenience of description, these two diagonal lines are also shown.

FIG. 15B is a diagram showing an example of the center of the region according to the embodiment.

In the example of FIG. 15B, for a rectangular 12-th region H12, a line parallel to the vertical direction drawn to bisect a width in the horizontal direction is defined as a first center line 421.

FIG. 15C is a diagram showing an example of the center of the region according to the embodiment.

In the example of FIG. 15C, for a rectangular 13-th region H13, a line parallel to the horizontal direction drawn to bisect a height in the vertical direction is defined as a second center line 431.

In the example of FIG. 14A, when a center point as shown in FIG. 15A or a center line as shown in FIG. 15B or 15C is used as a reference, the centers of the 1g region H1g and the 2g region H2g do not coincide.

Similarly, in the example of FIG. 14B, when the center point as shown in FIG. 15A or the center line as shown in FIG. 15B or 15C is used as a reference, the centers of the 1h region H1h and the 2g region H2g do not coincide.

Considering a case in which the 1g region H1g moves in a positive direction of the X axis from the state shown in FIG. 14A to become the 1h region H1h shown in FIG. 14B, there may be a state in which the center of the moving 1g region H1g overlaps and coincides with the center of the 2g region H2g in the middle of the movement.

In the display method according to the embodiment, the first master image G1 is acquired, the first aspect ratio of the first display screen B1 of the first display device A1 is acquired, the first region H1 is set in the first master region F1 of the first master image G1 based on the first aspect ratio, and the first image C1 obtained by trimming an image portion inside the first region H1 in the first master image G1 is displayed on the first display screen B1.

In the display method according to the embodiment, the second aspect ratio of the second display screen B2 of the second display device A2 different from the first display device A1 is acquired, the second region H2 having the overlapping region that overlaps the first region H1 and having the non-overlapping region that does not overlap the first region H1 in at least one of the first direction and the second direction orthogonal to each other in the first master region F1 is set in the first master region F1, based on the second aspect ratio, and the second image C2 in which the image portion inside the second region H2 in the first master image G1 is trimmed is displayed on the second display screen B2.

Therefore, in the display method according to the embodiment, for example, by generating the first image C1 and the second image C2 from the first master image G1 instead of generating the second image from the first image, it is possible to display an image matching the aspect ratio of each of the first display screen B1 and the second display screen B2, and for example, it is possible to prevent both sides of the second image from being black images.

Here, in the example of FIG. 7, the first direction is a direction parallel to the Y axis, and the second direction is a direction parallel to the X axis.

Here, a case in which the transmitter is the first display device A1 and the receiver is the second display device A2 is described as an example. For example, even when the receiver is the third display device A3, the same effect can be obtained except for a difference that the second display device A2 is a projector and the third display device A3 is a tablet terminal.

In the display method according to the embodiment, as a configuration example, first rotation information of the first display screen B1 of the first display device A1 is acquired, and a first aspect ratio is acquired based on the first rotation information.

Therefore, in the display method according to the present embodiment, it is possible to display an image suitable for an aspect ratio of each of the first display screen B1 and the second display screen B2 based on the screen rotation function of the first display device A1.

Here, the first rotation information is information regarding that a screen is rotated by the screen rotation function of the first display device A1, and includes, for example, a rotation amount such as a rotation angle. When the first display screen B1 of the first display device A1 is rotated, the first aspect ratio is changed, and thus a master image, a first region, and a second region may be changed.

Such a configuration may not be used.

In the display method according to the embodiment, as a configuration example, second rotation information of the second display screen B2 of the second display device A2 is acquired, and a second aspect ratio is acquired based on the second rotation information.

Therefore, in the display method according to the present embodiment, it is possible to display an image suitable for an aspect ratio of each of the first display screen B1 and the second display screen B2 based on the screen rotation function of the second display device A2.

Here, the second rotation information is information regarding that a screen is rotated by the screen rotation function 4 the second display device A2, and includes, for example, a rotation amount such as a rotation angle. When the second display screen B2 of the second display device A2 is rotated, the second aspect ratio is changed, and thus the master image, the first region, and the second region may be changed.

Such a configuration may not be used.

In the display method according to the embodiment, as a configuration example, the aspect ratio of the first master image G1 is the same as the second aspect ratio.

Therefore, in the display method according to the embodiment, when the first master image G1 is acquired, the data to be acquired is minimized.

Such a configuration may not be used.

In the display method according to the embodiment, as a configuration example, a length of the first region H1 in a first direction is greater than a length of the first region H1 in a second direction, and the length of the first region H1 in the first direction is the same as a length of the second region in the first direction.

Therefore, in the display method according to the embodiment, it is possible to display an image displayed on the first display screen B1 on the second display screen B2 to the maximum extent and to utilize a display region of the second display screen B2 to the maximum extent. Such a configuration may not be used.

In the display method according to the embodiment, as a configuration example, the length of the second region H2 in the second direction is the same as a length of the first master region F1 in the second direction, and the length of the second region H2 in the first direction is smaller than the length of the first master region F1 in the first direction.

Therefore, in the display method according to the embodiment, it is possible to optimally display an image to be displayed in accordance with each aspect ratio.

Such a configuration may not be used.

In the display method according to the embodiment, as a configuration example, a center of the first region H1 and a center of the second region H2 do not coincide.

Therefore, in the display method according to the embodiment, any range inside the first master image G1 can be displayed on a predetermined screen. The predetermined screen may be, for example, a screen of a smartphone.

Such a configuration may not be used.

The display system 1 according to the embodiment can implement processing corresponding to various configurations of the display method according to the embodiment.

As a configuration example, the display system 1 according to the embodiment includes the first display device A1 and the second display device A2.

The first display device A1 acquires the first master image G1, acquires the first aspect ratio of the first display screen B1 of the first display device A1, sets the first region H1 in the first master region F1 of the first master image G1 based on the first aspect ratio, and displays, on the first display screen B1, the first image C1 obtained by trimming an image portion inside the first region H1 in the first master image G1.

The first display device A1 or the second display device A2 acquires the second aspect ratio of the second display screen B2 of the second display device A2, and sets, in the first master region F1, the second region H2 having an overlapping region that overlaps the first region H1 and having a non-overlapping region that does not overlap the first region H1 in at least one of the first direction and the second direction orthogonal to each other in the first master region F1, based on the second aspect ratio.

The second display device A2 displays, on the second display screen B2, the second image C2 obtained by trimming the image portion inside the second region H2 in the first master image G1.

Therefore, in the display system 1 according to the embodiment, for example, by generating the first image C1 and the second image C2 from the first master image G1 instead of generating the second image from the first image, it is possible to display an image matching the aspect ratio of each of the first display screen B1 and the second display screen B2, and for example, it is possible to prevent both sides of the second image from being black images.

Here, the acquisition of the second aspect ratio and the setting of the second region H2 based on the second aspect ratio may be performed by, for example, the first display device A1 or the second display device A2.

It is possible to record a program for implementing the function of any element in any apparatus described hereinabove on a computer-readable recording medium, and make a computer system read and then execute the program. The “computer system” mentioned here includes an operating system or hardware such as peripheral equipment. The “computer-readable recording medium” is a portable medium such as a flexible disk, a magneto-optical disk, a read only memory (ROM), or a compact disc (CD)-ROM, or a storage device such as a hard disk incorporated in the computer system. Further, the “computer-readable recording medium” includes what retains a program for a certain period of time such as a volatile memory located inside the computer system serving as a server or a client when the program is transmitted via a network such as the Internet or a communication line such as a telephone line. The volatile memory may be a RAM. The recording medium may be a non-transitory recording medium.

The program described above may be transmitted from a computer system in which the program is stored in a storage device or the like to another computer system via a transmission medium or by a transmission wave in the transmission medium. The “transmission medium” for transmitting the program refers to a medium including a function of transmitting information like a network such as the Internet or a communication line such as a telephone line.

The program described above may be a program for implementing a part of the functions described above. The program described above may be a so-called differential file that can achieve the function described above in combination with a program already recorded on the computer system. The differential file may be referred to as a differential program.

The function of any element in any apparatus described hereinabove may be implemented by a processor. Each processing in the embodiment may be implemented by a processor that operates based on the information such as a program and a computer-readable recording medium that stores the information such as a program. In the processor, the function of each unit may be implemented by individual hardware, or the function of each unit may be implemented by integrated hardware. The processor may include hardware, and the hardware may include at least one of a circuit that processes a digital signal and a circuit that processes an analog signal. The processor may be implemented using one or both of a single circuit device or a plurality of circuit devices mounted on a circuit board, and a single circuit element or a plurality of circuit elements. An integrated circuit (IC) or the like may be used as the circuit device, and a resistor, a capacitor, and so on may be used as the circuit element.

The processor may be a CPU. However, the processor is not limited to the CPU, and various processors such as a graphics processor (GPU) or a digital signal processor (DSP) may be used. The processor may be a hardware circuit using an application specific integrated circuit (ASIC). The processor may include a plurality of CPUs, or may include a hardware circuit including a plurality of ASICs. The processor may be implemented by a combination of a plurality of CPUs and a hardware circuit including a plurality of ASICs. The processor may include one or more of an amplifier circuit, a filter circuit, or the like that processes an analog signal.

While the embodiment is hereinabove described in detail with reference to the drawings, the specific configurations are not limited to the embodiment, and include designs and the like without departing from the scope of the present disclosure.

### Summary of Present Disclosure

A summary of the present disclosure will be appended below.

### APPENDIX 1

A display method includes:
acquiring a master image;
acquiring a first aspect ratio of a first display screen of a first display device;
setting a first region in a master region of the master image based on the first aspect ratio;
displaying, on the first display screen, a first image obtained by trimming an image portion inside the first region in the master image;
acquiring a second aspect ratio of a second display screen of a second display device different from the first display device;
setting, in the master region, a second region having an overlapping region that overlaps the first region and a non-overlapping region that does not overlap the first region in at least one of a first direction and a second direction that are orthogonal to each other in the master region, based on the second aspect ratio; and
displaying, on the second display screen, a second image obtained by trimming an image portion inside the second region in the master image.

Accordingly, for example, by generating the first image and the second image from the master image instead of generating the second image from the first image, it is possible to display an image matching the aspect ratio of each of the first display screen and the second display screen, and for example, it is possible to prevent both sides of the second image from being black images.

### APPENDIX 2

The display method according to (Appendix 1), further includes:
acquiring first rotation information of the first display screen of the first display device, and
the first aspect ratio is acquired based on the first rotation information.

Accordingly, it is possible to display an image suitable for an aspect ratio of each of the first display screen and the second display screen based on the screen rotation function of the first display device.

### APPENDIX 3

The display method according to (Appendix 1) or (Appendix 2), further includes:
acquiring second rotation information of the second display screen of the second display device, and
the second aspect ratio is acquired based on the second rotation information.

Accordingly, it is possible to display an image suitable for an aspect ratio of each of the first display screen and the second display screen based on the screen rotation function of the second display device.

### APPENDIX 4

In the display method according to any one of (Appendix 1) to (Appendix 3),
an aspect ratio of the master image is the same as the second aspect ratio.

Accordingly, when the master image is acquired, data to be acquired is minimized.

### APPENDIX 5

In the display method according to (Appendix 4),
a length of the first region in the first direction is greater than a length of the first region in the second direction, and
the length of the first region in the first direction is the same as a length of the second region in the first direction.

Accordingly, it is possible to display an image displayed on the first display screen on the second display screen to the maximum extent and to utilize a display region of the second display screen to the maximum extent.

### APPENDIX 6

In the display method according to any one of (Appendix 1) to (Appendix 3),
a length of the second region in the second direction is the same as a length of the master region in the second direction, and
a length of the second region in the first direction is less than a length of the master region in the first direction.

Accordingly, it is possible to optimally display an image to be displayed in accordance with each aspect ratio.

### APPENDIX 7

In the display method according to any one of (Appendix 1) to (Appendix 6),
a center of the first region and a center of the second region do not coincide.

Accordingly, any range inside the master image can be displayed on a predetermined screen of a smartphone or the like.

### APPENDIX 8

A display system includes:
a first display device; and
a second display device, wherein
the first display device
   acquires a master image, acquires a first aspect ratio of a first display screen of the first display device,
   sets a first region in a master region of the master image based on the first aspect ratio, and
   displays, on the first display screen, a first image obtained by trimming an image portion inside the first region in the master image,
the first display device or the second display device
   acquires a second aspect ratio of a second display screen of a second display device, and
   sets, in the master region, a second region having an overlapping region that overlaps the first region and a non-overlapping region that does not overlap the first region in at least one of a first direction and a second direction that are orthogonal to each other in the master region, based on the second aspect ratio, and
the second display device displays, on the second display screen, a second image obtained by trimming an image portion inside the second region in the master image.

Accordingly, for example, by generating the first image and the second image from the master image instead of generating the second image from the first image, it is possible to display an image matching the aspect ratio of each of the first display screen and the second display screen, and for example, it is possible to prevent both sides of the second image from being black images.

What is claimed is:

1. A display method comprising:
acquiring a master image;
acquiring a first aspect ratio of a first display screen of a first display device;
setting a first region in a master region of the master image based on the first aspect ratio;
displaying, on the first display screen, a first image obtained by trimming an image portion inside the first region in the master image;
acquiring a second aspect ratio of a second display screen of a second display device different from the first display device;
setting, in the master region, a second region having an overlapping region that overlaps the first region and a non-overlapping region that does not overlap the first region in at least one of a first direction and a second direction that are orthogonal to each other in the master region, based on the second aspect ratio; and
displaying, on the second display screen, a second image obtained by trimming an image portion inside the second region in the master image.

2. The display method according to claim 1, further comprising:
acquiring first rotation information of the first display screen of the first display device, wherein
the first aspect ratio is acquired based on the first rotation information.

3. The display method according to claim 1, further comprising:
acquiring second rotation information of the second display screen of the second display device, wherein
the second aspect ratio is acquired based on the second rotation information.

4. The display method according to claim 1, wherein
an aspect ratio of the master image is the same as the second aspect ratio.

5. The display method according to claim 4, wherein
a length of the first region in the first direction is greater than a length of the first region in the second direction, and
the length of the first region in the first direction is the same as a length of the second region in the first direction.

6. The display method according to claim 1, wherein
a length of the second region in the second direction is the same as a length of the master region in the second direction, and
a length of the second region in the first direction is less than a length of the master region in the first direction.

7. The display method according to claim 1, wherein
a center of the first region and a center of the second region do not coincide.

8. A display system comprising:
a first display device; and
a second display device, wherein
the first display device
acquires a master image,
acquires a first aspect ratio of a first display screen of the first display device,
sets a first region in a master region of the master image based on the first aspect ratio, and
displays, on the first display screen, a first image obtained by trimming an image portion inside the first region in the master image,
the first display device or the second display device
acquires a second aspect ratio of a second display screen of the second display device, and
sets, in the master region, a second region having an overlapping region that overlaps the first region and a non-overlapping region that does not overlap the first region in at least one of a first direction and a second direction that are orthogonal to each other in the master region, based on the second aspect ratio, and
the second display device displays, on the second display screen, a second image obtained by trimming an image portion inside the second region in the master image.
